(19) United States
(12) Patent Application Publication
(10) Pub. No.: US 2022/0168874 A1
(43) Pub. Date: Jun. 2, 2022

(54) FASTENER POSITION HOLDING TOOL

(71) Applicant: Product Launch Advisors, LLC, Rock Hill, SC (US)

(72) Inventor: Richard O. Gregory, II, Rock Hill, SC (US)

(21) Appl. No.: 17/537,893

(22) Filed: Nov. 30, 2021

Related U.S. Application Data
(60) Provisional application No. 63/119,575, filed on Nov. 30, 2020.

(51) Int. Cl. B25B 23/10; B25B 23/00; E02F 9/28

(52) U.S. Cl. CPC B25B 23/10; E02F 9/2891; B25B 23/0085

(57) ABSTRACT

A tool can include a structural member defining a hub and at least one arm extending from the hub; and a mounting fastener secured to the arm of the structural member at a position distal from the hub and configured to automatically adjust to and hold itself in place against a non-flat mating surface of a structure, the tool configured to contact and maintain a position of a fastener assembly in a direction of an axis of the fastener assembly.

### REFERENCE TO RELATED APPLICATIONS

This application claims the benefit of U.S. Provisional Application No. 63/119,575, filed Nov. 30, 2020, which is hereby specifically incorporated by reference herein in its entirety.

### TECHNICAL FIELD

### Field of Use

This disclosure relates to tools for holding at least a portion of a fastener in place during assembly or removal. More specifically, this disclosure relates to tools for holding at least a portion of a fastener in place during assembly or removal, the tools being able to compensate for a height of the portion of the fastener.

### Related Art

Removing assembled portions of a fastener assembly (e.g., a head or nut of a threaded fastener assembly) can be as simple as engaging a fastener removal tool (e.g., a wrench or socket) to the head or the nut and rotating the tool until the fastener assembly has been loosened and disassembled. In some aspects, however, it can be beneficial or necessary to hold one side of the fastener assembly while the other side is engaged with the fastener removal tool. While it can be convenient for a user (e.g., a mechanic) to directly hold the one side of the fastener assembly with his or her hand, direct contact with the one side of the fastener assembly while the other side is engaged with the fastener removal tool, which often produces high RPM (revolutions per minute, i.e., a rotational speed of the fastener removal tool), high torque, and/or high temperature in the fastener assembly, can result in a safety risk to the mechanic.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a tool comprising: a structural member defining a hub and at least one arm extending from the hub; and a mounting fastener secured to the structural member and configured to hold itself in place against a mating surface. In a related aspect, disclosed is a tool comprising: a structural member defining a hub and at least one arm extending from the hub; and a mounting fastener secured to the arm of the structural member at a position distal from the hub and configured to automatically adjust to and hold itself in place against a non-flat mating surface of a structure, the tool configured to contact and maintain a position of a fastener assembly in a direction of an axis of the fastener assembly.

In a further aspect, disclosed is a tool comprising: a mounting fastener defining a cavity configured to hold itself in place against a mating surface; and a holding fastener adjustably secured to and extending through the mounting fastener and into the cavity. In a related aspect, disclosed is a tool comprising: a mounting fastener configured to hold itself in place against a mating surface of a structure, the mounting fastener comprising a magnet; and one of a spacer and a holding fastener, the one of the spacer and the holding fastener secured to a surface of the tool, the one of the spacer and the holding fastener positioned inside a cavity defined by the mounting fastener, a position of a surface of the spacer and a tip of the holding fastener being adjustable with respect to a working end of the mounting fastener in a direction of an axis of a fastener assembly, the one of the spacer and the holding fastener configured to contact and maintain a position of the fastener assembly extending through the structure in the direction of the axis of the fastener assembly.

In yet another aspect, disclosed is a method of using a tool, the method comprising: aligning an axis of a holding fastener of a tool with a first connecting portion of a fastener assembly, the fastener assembly securing a first structure to a second structure; securing a mounting fastener of the tool to the first structure, the mounting fastener configured to hold itself in place against a mating surface of the first structure; and adjusting the holding fastener to prevent premature dislocation of the first connecting portion from the first structure. In a related aspect, disclosed is a method of using a tool, the method comprising: aligning one of a spacer and a holding fastener of the tool with a first connecting portion of a fastener assembly, the fastener assembly configured to secure a first structure to a second structure, the first structure being a wearable blade; and securing a mounting fastener of the tool to the first structure, the mounting fastener configured to automatically adjust to and hold itself in place against a non-flat mating surface of the first structure.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1A is a top perspective view of a tool in accordance with one aspect of the current disclosure.

FIG. 1B is a side elevation view of the tool of FIG. 1A.

FIG. 2 is a side elevation view of a tool in accordance with another aspect of the current disclosure.

FIG. 3A is a bottom perspective view of a tool in accordance with another aspect of the current disclosure.

FIG. 3B is a top perspective exploded view of the tool of FIG. 3A.

FIG. 4A is a top perspective view of a tool in accordance with another aspect of the current disclosure.

FIG. 4B is a bottom perspective view of the tool of FIG. 4A.

FIG. 5A is a top perspective view of a tool in accordance with another aspect of the current disclosure.

FIG. 5B is a bottom perspective view of the tool of FIG. 5A.

FIG. 6 is a front perspective view of a construction vehicle comprising a bucket, a bucket blade, and a plurality of fastener assemblies securing the bucket blade to the bucket in accordance with one aspect of the current disclosure.

FIG. 7 is a side bottom perspective view of the tool of FIG. 1A installed on the bucket of the construction vehicle of FIG. 6.

FIG. 8A is a sectional view of the tool of FIG. 1A installed on the bucket of the construction vehicle of FIG. 6 and with a holding fastener of the tool in contact with the fastener assembly of the bucket taken along line 8A-8A of FIG. 7.

FIG. 8B is a sectional view similar to that of FIG. 8A but taken along line 8B-8B of FIG. 11C in accordance with one aspect of the current disclosure.

FIG. 9 is a side bottom perspective view of the tool of FIG. 1A during removal from the bucket of the construction vehicle of FIG. 6.

FIG. 10 is a top perspective exploded view of a tool comprising suction cups as the mounting fasteners in accordance with another aspect of the current disclosure.

FIG. 11A is a side view of a tool in accordance with another aspect of the current disclosure.

FIG. 11B is a bottom perspective view of a tool in accordance with another aspect of the current disclosure.

FIG. 11C is a side view of the tool of FIG. 11B.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

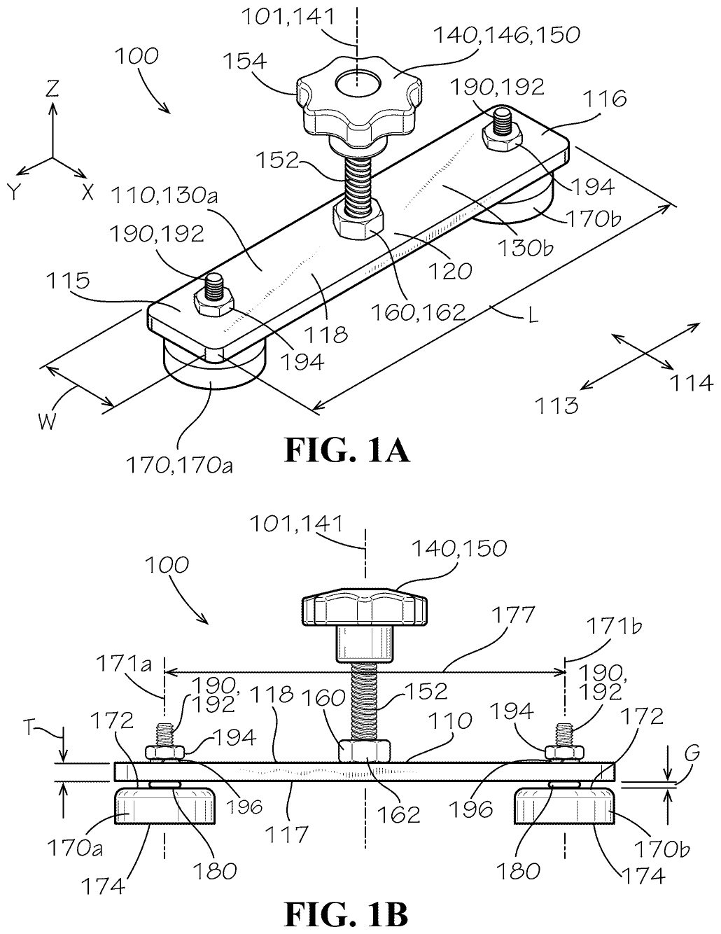

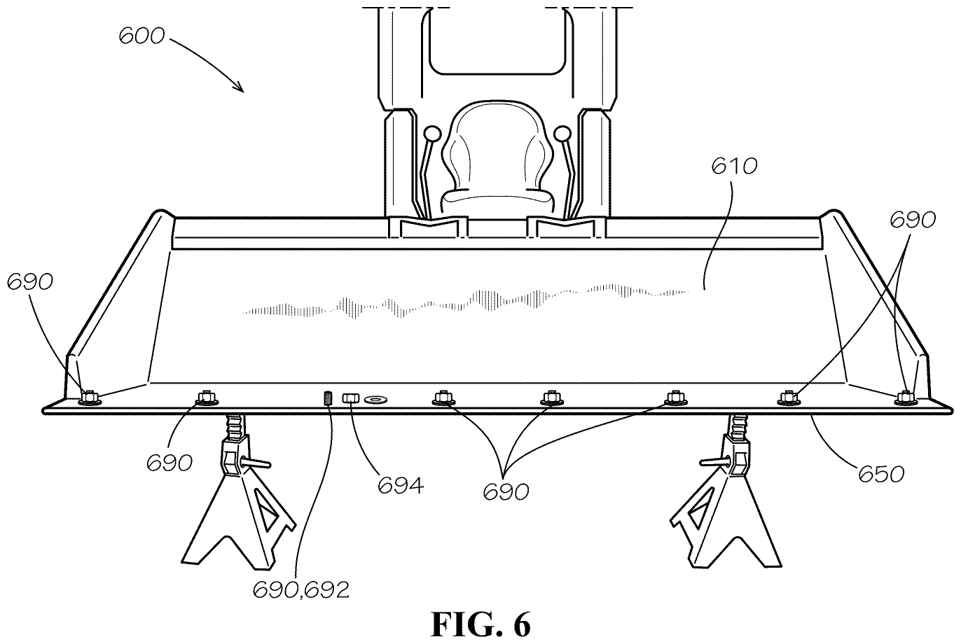

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of a vehicle 600 (shown in FIG. 6) in front of a user of the vehicle 600—or a tool 100 (shown in FIG. 1A) used thereon—from the perspective of the user; “rear” is that end of the seat that is opposite or distal the front; “left” is that which is to the left of or facing left from a person sitting in the vehicle 600 and facing towards the front; and “right” is that which is to the right of or facing right from that same person while sitting in the vehicle 600 and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

Alternatively, the tool 100 can be described below on the basis of a coordinate axis of X-Y-Z directions shown in the figures. An X-axis direction can be referred to as a left-right or horizontal direction. For example, as shown in FIG. 1, the X-axis direction coincides with a width of a structural member 110 of the tool 100. A Y-axis direction is orthogonal to the X-axis direction (left-right direction) and a Z-axis direction (upper-lower direction) and can also be referred to as a front-rear direction. A surface of a structural element that is parallel with the front-rear direction can be referred to as a lateral side. An upper-lower direction is the Z-axis direction, which is orthogonal to the X-axis direction and to the Y-axis direction and typically coincides with a height direction of the tool 100.

In one aspect, a tool and associated methods, systems, devices, and various apparatuses are disclosed herein. In one aspect, the tool can be a fastener position holding tool and can comprise a magnet and a holding fastener.

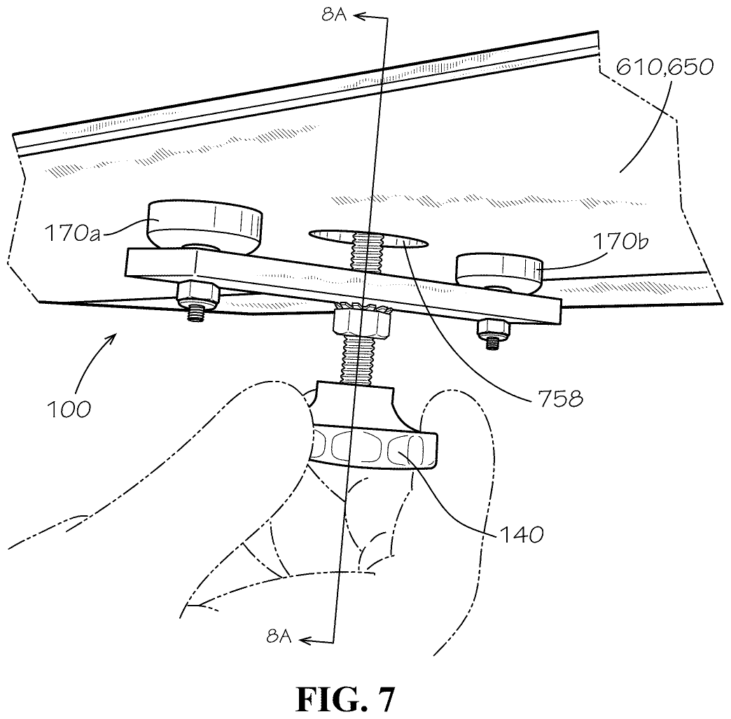

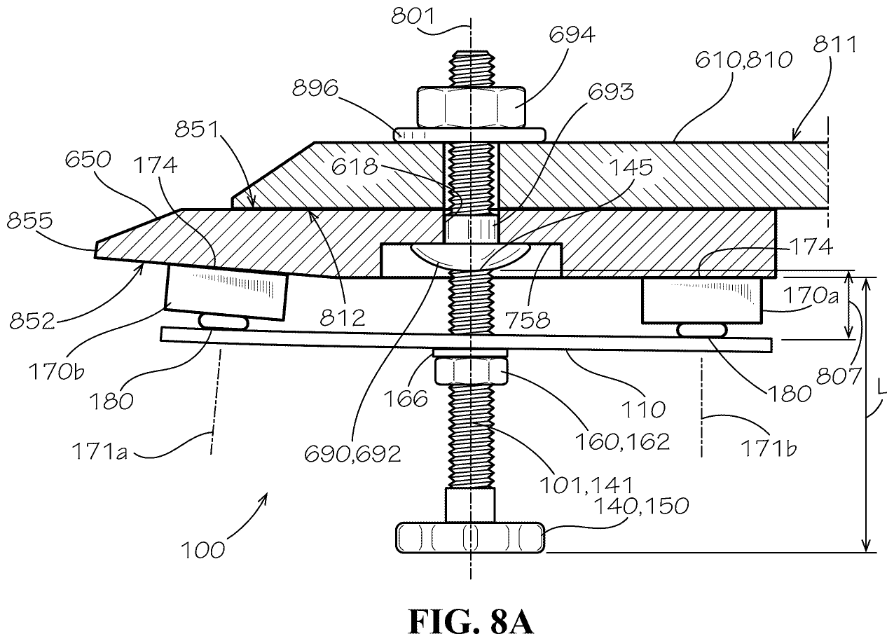

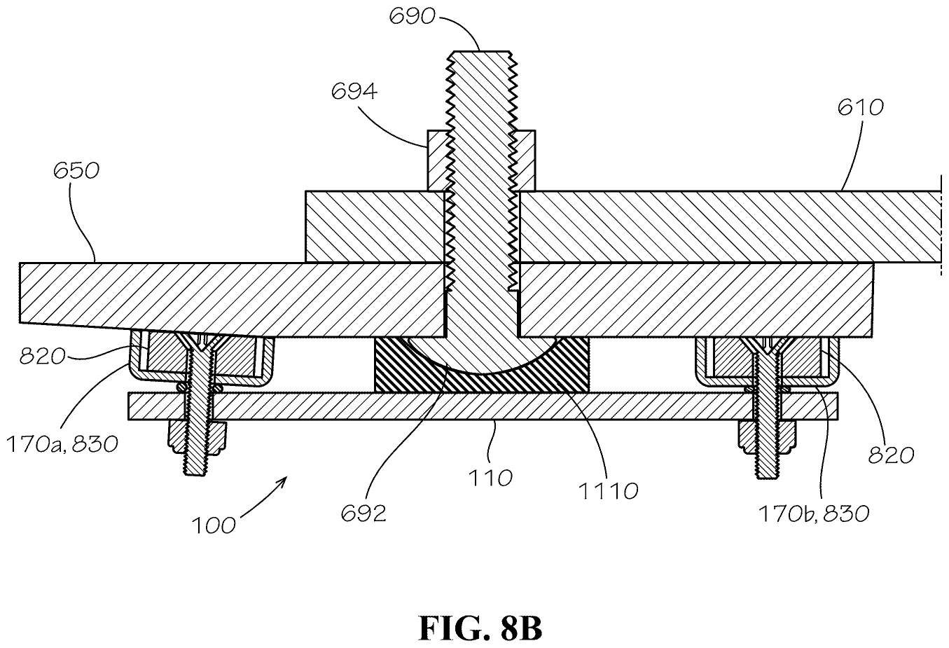

FIG. 1A is a top perspective view of a tool 100 in accordance with one aspect of the current disclosure. The tool 100, which can be a fastener holding tool, can be used to more safely disassemble fastener assemblies. More specifically, the tool 100 can be configured to contact and maintain a position of a fastener assembly 690 (shown in FIG. 6) in a direction angled with respect to or, more specifically, perpendicular to a mating surface of a structure. For example, a user of the tool 100 (e.g., a mechanic) can with the tool 100 avoid direct contact with either side of any one of a plurality of fastener assemblies 690 securing a blade 650 (shown in FIG. 6) to a bucket 610 (shown in FIG. 6) of a vehicle 600 (shown in FIG. 6) such as, for example and without limitation, a skid steer or bulldozer or other construction vehicle or equipment. The blade 650, which can be a bucket blade, can be any wearable blade on the vehicle 600 or equipment. As shown in FIG. 7 and described in further detail in a description of FIG. 7 below, the user can engage a stationary side of the fastener assembly 690 with the tool 100 while engaging the other side with a fastener removal tool (e.g., a wrench or a socket). This can be beneficial when, due to vibration or gravity or other influencing factors, the portion of the fastener assembly 690 being held in place by the tool 100 would not otherwise remain in a position necessary to keep the fastener assembly 690 stationary. For example, a user may need to use an impact tool or hammer-action tool to apply a more jarring removal torque to remove a rusty or worn fastener assembly, and significant vibration can result from such use. More specifically, a portion of the fastener assembly 690 such as a first connecting portion 692 (shown in FIG. 6), which can be or can comprise a bolt, can be configured to lock (i.e., not rotate) within a hole of the blade 650 through which the first connecting portion 692 extends—for example and without limitation, when the first connecting portion 692 is a carriage bolt—and the tool 100 can keep the first connecting portion 692 engaged with the blade 650 during removal of a second connecting portion 694 (shown in FIG. 6) of the fastener assembly 690. More specifically, a shank portion 693 (shown in FIG. 8A) of the first connecting portion 692 that is square in shape can remain engaged with a hole 618 (shown in FIG. 8A) defined in the bucket 610 as long as the first connecting portion 692 is held in an engaged position (i.e., engaged with the hole 618 so as to prevent rotation of the first connecting portion 692) by the tool 100.

The tool 100 can comprise a structural member 110, a holding fastener 140, and at least one tool mounting fastener 170. In some aspects, the structural member 110 can be a bar or plate. More specifically, the structural member 110 can comprise or define a hub 120 and one or more arms 130a,b, each of which can extend from the hub 120 in a radial direction with respect to an axis 101 of the tool 100 or an axis 141 of the holding fastener 140. As shown, the structural member 110 can comprise the two arms 130a,b, each of which can extend from the hub 120 in the radial direction and in a longitudinal direction 113. In some aspects, each of the arms 130a,b of the structural member 110 and any portions of the tool 100 can be radially symmetric about one or both of the axes 101,141. As shown, the structural member 110 can define a length L in the longitudinal direction 113 and a width W in a transverse direction 114, and a thickness T (shown in FIG. 1B). It can be beneficial for the structural member 110 to be strong enough to resist bending or other deformation under use so that pressure applied to the fastener assembly 690 and, more specifically, the first connecting portion 692 does not cause the structural member 110, and thereby also the holding fastener 140, to move away from and apply less holding force to or even separate from the first connecting portion 692. In some aspects, as shown, the structural member 110 can define a substantially rectangular shape (i.e., substantially rectangular minus, for example, edge treatments defined at corners of the structural member 110). In some aspects, for example and without limitation, the length L can be five inches, the width W can be one inch, and the thickness T can be 3/16 inch. The structural member 110 can define a first end 115, a second end 116, a first side 117 (shown in FIG. 1B), and a second side 118.

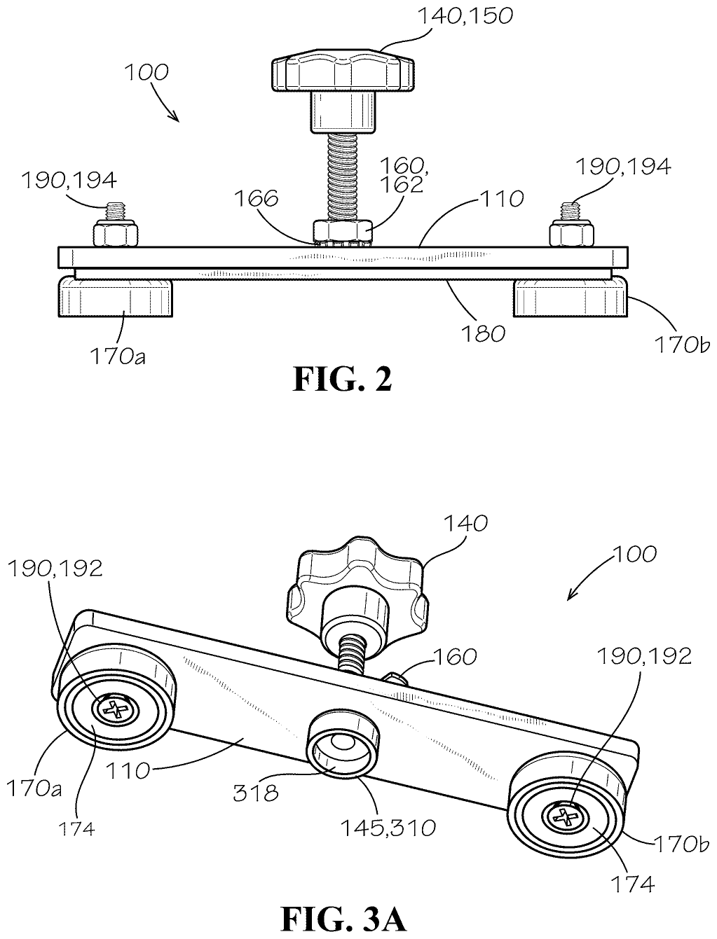

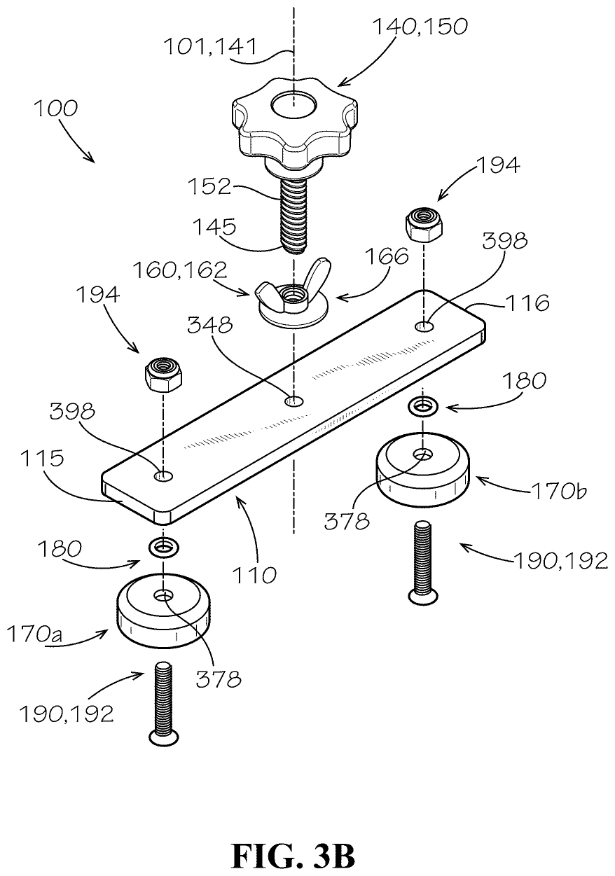

The holding fastener 140 can be adjustably secured to the structural member 110 and can extend through the hub 120 of the structural member 110. The holding fastener 140 can define a first end 145 (shown in FIG. 3A) and a second end 146 distal from the first end 145. The first end 145 of the holding fastener 140 can be adjustably secured to and can extend through the structural member 110. The holding fastener 140 can comprise a main portion 150 and a locking portion 160.

The main portion 150 of the holding fastener 140 can comprise a shaft 152 and a head 154, which can comprise or define a knob. The head 154 and, more specifically, the knob can define a plurality of lobes or ridges extending radially outward to ease rotation of and tightening of the holding fastener 140 with a hand of a user of the tool 100. As shown, the head 154 can define seven lobes, although in other aspects any number of lobes or ridges can be defined in the head 154. In any case, the head 154 can define a diameter that is greater than a diameter of the shaft 152 and which can vary with respect to an axial position along the axis 141. The locking portion 160 of the holding fastener 140 can comprise a locking fastener 162, which can comprise or can be a nut. In some aspects, the locking fastener 162 can be a locking nut or a lock nut. In some aspects, any individual portion of the holding fastener 140 can be formed from multiple materials or components. In other aspects, the holding fastener 140 or any individual portion thereof can be formed monolithically, i.e., as a single piece of material.

The locking portion 160 of the holding fastener 140 can be adjustably positioned adjacent to the structural member 110 and can receive the shaft 152 of the main portion 150. The axis 141 of the holding fastener 140 and an axis of the shaft 152 can be angled with respect to the structural member 110. More specifically, the axis 141 and the axis of the shaft 152 can be angled at 90 degrees with respect to the structural member 110. The locking portion 160 can be configured to lock a rotational position of the holding fastener 140 with respect to the structural member 110. As shown, the locking portion 160 can be a hex nut.

The tool 100 can comprise a plurality of mounting fasteners 170a,b, which can be synonymous with the mounting fastener 170. One or more of the mounting fasteners 170a,b can, in some aspects, comprise a magnet or magnetized material configured to be magnetically attracted to a ferromagnetic material. Such a magnet can be a rare-earth magnet such as, for example and without limitation, neodymium. More specifically, the magnet can be an NdFeB magnet made from an alloy of neodymium, iron, and boron. For example and without limitation, as shown, the magnet can define a diameter of one inch and a height of 0.315 inches and can comprise a magnet 820 (shown in FIG. 8B) received within a fastener body 830 (shown in FIG. 8B). In some aspects, the magnet 820 can be donut-shaped or can define an annular shape. In some aspects, each of the mounting fasteners 170a,b and, more specifically, a magnet thereof can define an attraction force or attachment force in a range of 15 to 120 pounds of force. In some aspects, each of the mounting fasteners 170a,b and, more specifically, a magnet thereof can define an attraction force or attachment force in a range of 50 to 60 pounds of force. In some aspects, each of the mounting fasteners 170a,b and, more specifically, a magnet thereof can define, depending on a material forming the magnet and the size and configuration of the magnet, an attraction force of less than or greater than the range of 50 to 60 pounds of force. In some aspects, it can be beneficial for the attachment force to be greater than the vibration the fastener assembly 690 experiences during removal and stronger than the downward force (i.e., towards the tool 100) applied to the second connecting portion 694 during the process of removing the second connecting portion 694 from the first connecting portion 692. In some aspects, as shown, each of the mounting fasteners 170a,b can define a cylindrical shape, and a first surface 172 (shown in FIG. 1B) thereof can be circular. In other aspects, each of the mounting fasteners 170a,b can define a non-cylindrical shape.

In some aspects, each of the mounting fasteners 170a,b can comprise an electromagnet, which can be activated through the flow of current through a coil contained therein. By adjusting the amount of current or turning off the current, the magnetic force can be increased or decreased or removed altogether such as, for example and without limitation, during removal of the tool 100 from a mating structure such as the bucket 610 (shown in FIG. 6).

The mounting fastener 170a,b need not comprise a magnet or magnetized material. In other aspects, one or more of the mounting fasteners 170a,b can comprise a suction cup or other fastener able to be secured to a surface such as a lower surface of the blade 650 of the bucket 610. In some aspects, the mounting fastener 170a,b does not require a mechanical connection. In some aspects, the mounting fastener 170a,b can comprise one or more fasteners making a mechanical connection. In some aspects, for example, each of the mounting fasteners 170a,b can comprise a fastener (not shown) such as a bolt or screw extending into or through the bucket 610 or other mating structure to secure the mounting fastener 170a,b to the bucket 610 or other mating structure. In some aspects, one portion of a mounting fastener such as a hook portion of a hook-and-loop fastener can be secured to the mating structure and a second portion of the mounting fastener such as a loop portion of the hook-and-loop fastener can be secured to the structural member 110.

Each of the mounting fasteners 170a,b can be secured to the structural member 110 with a fastener 190, which can comprise a first connecting portion 192 and a second connecting portion 194. The first connecting portion 192 can be any suitable fastener including one containing a shaft such as, for example and without limitation, a bolt or a screw or a pin. The second connecting portion 194 can be any suitable fastener including one defining a hole for receiving the shaft of the first connecting portion 192 such as, for example and without limitation, a nut or cotter pin. As shown, each of the fasteners 190 can be angled at 90 degrees with respect to the structural member 110. At the same time, however, each of the fasteners 190 can be free to rotate with respect to the default orientation—and sufficient play can be provided in the openings 398 (shown in FIG. 3B) defined in the structural member 110—to allow movement of the mounting fasteners 170a,b.

FIG. 1B is a side elevation view of the tool 100. As shown, the mounting fastener 170a can define the first surface 172 proximate to the structural member 110 and a working surface or second surface 174 distal from the first surface 172. Each of the mounting fasteners 170a,b and the corresponding fasteners 190 can be aligned and can be secured to the structural member 110 along respective axes 171a,b, each of which can be angled with respect to the structural member 110. More specifically, each of the axes 171a,b can be angled at 90 degrees with respect to the structural member 110 in a default position but, as described below, can rotate to form a different angle with respect to the structural member 110. In some aspects, a washer 196, which can be a lock washer, can be positioned between the second connecting portion 194 and the structural member 110. The washer 196 can be used to set a gap G between the first side 117 of the structural member and the first surface 172 of the corresponding mounting fastener 170a,b. A center-to-center spacing 177 between the axes 171a,b can be increased or decreased for, generally speaking, more or less flexibility. In some aspects, as shown, the structural member 110 can be flat and can be formed from a blank of material.

A spacer 180 can be positioned between the structural member 110 and the corresponding mounting fastener 170a,b. As shown, the spacer 180 can define an annular shape and can be an O-ring. The spacer 180 can be at least one of an elastic and a compressible material and, as such, can be configured to allow movement of the mounting fastener 170a,b with respect to the structural member 110. More specifically, the spacer 180 can be configured to allow one of rotation of the mounting fastener 170a,b about an axis orthogonal to the corresponding axis 171a,b and translation of the mounting fastener 170a,b along the corresponding axis 171a,b of the of the mounting fastener 170a,b in an adjustment direction corresponding to the Z-axis (shown in FIG. 1) of the tool 100. An elastic material such as, for example and without limitation, natural or synthetic rubber, EPDM, or silicone can form the spacer 180 and can define a desired hardness. A compressible material such as, for example and without limitation, foam (including EPDM foam) can form the spacer 180 and can be compressible in a desired range. In some aspects, a durometer of the material can be in a range between 30 and 80 on the Shore A scale. The spacer 180 can compress to a thickness equal or less than the gap G. In some aspects, the spacer 180 can dampen vibrations in the tool 100 and thereby limit vibrational forces from directly causing vibration and dislocation of the mounting fasteners 170a,b, and the hardness of the spacer 180 can be adjusted to control or minimize such vibration.

A separate shim (not shown) defining a desired thickness corresponding to the gap G can be positioned between the structural member 110 and the first surface 172 of the corresponding mounting fastener 170a to set the gap G therebetween. By adjusting the gap G up or down, a connection between the mounting fastener 170a,b and the structural member 110 can be made generally more or less flexible to adjust more readily to surfaces against which the tool 100 may be attached. For example and without limitation, the gap G can be set to 1/16 inch.

Upon tightening of the locking portion 160 of the holding fastener 140 and, more specifically, the locking fastener 162 against a surface of the structural member 110 such as, for example and without limitation, a surface of the second side 118, each of a rotational position and an axial position of the holding fastener 140 can be fixed with respect to the structural member 110. The shaft 152 of the holding fastener 140 is shown not yet extending beyond a surface of the first side 117 of the structural member 110.

FIG. 2 is a side elevation view of the tool 100 in accordance with another aspect of the current disclosure. As shown, the locking portion 160 can comprise a washer 166 such as, for example and without limitation, a locking washer. The washer 166 can be positioned between the locking fastener 162 and the structural member 110. In some aspects, as shown, the washer 166 can be an external tooth or “star” washer, which is a type of locking washer, and can facilitate rotational locking of the locking fastener 162 of the locking portion 160 with respect to the main portion 150 and the structural member 110.

In some aspects, as shown, the second connecting portion 194 of the fastener 190 can be a lock nut such as, for example and without limitation, a nylon lock nut resisting rotation about the first connecting portion 192 of the fastener 190 by a friction fit between an insert defined in a bore of the nut and formed from a resin such as, for example and without limitation, a polyamide such as nylon. In other aspects, the fastener 190 can comprise a washer (not shown), which can be positioned between the second connecting portion 194 and the structural member 110. The second connecting portion 194 can facilitate setting of the gap G (shown in FIG. 1B) by allowing the fastener 190 to be tightened to a certain degree and maintain such a position or tightened condition.

In some aspects, as shown, the spacer 180 can be a sheet or can be monolithic and can, in any case, extend across the structural member 110 and between each of the mounting fasteners 170a,b and the structural member 110. The spacer 180 can, in some aspects, define a substantially rectangular shape. In some aspects, a portion of the spacer 180 facing a head of the first connecting portion 692 (shown in FIG. 8A) can be an elastic and/or compressible material to protect the hands of a user from pinch hazards during attachment of the tool 100. More specifically, if and when a hand or a portion thereof is positioned between the tool 100 and a structure such as the bucket 610 (shown in FIG. 6), the spacer 180 can compress to avoid injury to the user.

FIG. 3A is a bottom perspective view of the tool 100 in accordance with another aspect of the current disclosure. A head of the first connecting portion 192 of each of the fasteners 190 can be countersunk to fit inside and sit flush with the corresponding mounting fastener 170a,b. The holding fastener 140 can comprise or define a tip 310 at a tip of the first end 145 of the holding fastener 140 and can define the first end 145. More specifically, the tip 310 can comprise a cup defining a clearance bore or clearance opening 318, the purpose of which will be described below. In some aspects, the tip 310 can comprise or can be a flat disc to increase a size and/or surface area of the first end 145 of the holding fastener 140 and thereby facilitate contact between the first end 145 of the holding fastener 140 and the fastener assembly 690 (shown in FIG. 8A), including when the axis 141 of the holding fastener 140 and/or the axis 101 of the tool 100 are not aligned with an axis 801 (shown in FIG. 8A) of the fastener assembly 690).

FIG. 3B is a top perspective exploded view of the tool 100 of FIG. 3A. As shown, the locking portion 160 of the holding fastener 140 can be or can comprise a wing nut defining wings, which can facilitate rotation and tightening of the locking portion 160 with respect to the main portion 150 of the holding fastener 140 and/or with respect to the structural member 110, particularly when a hand of a user of the tool 100, as opposed to a wrench, is used for direct tightening of the locking portion 160. The structural member 110 can define a main bore or main opening 348, which can be sized and otherwise configured to receive the holding fastener 140 and, more specifically, the first end 145 thereof. In some aspects, as shown, the first end 145 can define a plain end of the main portion 150 of the holding fastener 140 or, more specifically, the shaft 152 thereof. In some aspects, as also shown, a diameter of the holding fastener 140 and, more specifically, the shaft 152 thereof including the first end 145 can be constant. An exception can be an edge treatment on or other slight narrowing or widening of the shaft 152 at the first end 145. The structural member 110 can define the openings 398, each of which can be sized and otherwise configured to receive the corresponding fastener 190 and, more specifically, the first connecting portion 192 thereof. Each of the mounting fasteners 170a,b can define an opening 378, which can also be sized and otherwise configured to receive the corresponding fastener 190.

The main opening 348 can be aligned with the axes 101,141 of the tool 100 and the holding fastener 140, respectively. The openings 398 can be offset from the first end 115 and the second end 116, respectively, by a distance such as, for example and without limitation, one half inch. In some aspects, each of the shaft 152 of the main portion 150 and the locking fastener 162 of the locking portion 160 can be threaded. In other aspects, the shaft 152 or, more generally, the holding fastener 140, can be otherwise configured to move and be fixed, with or without indexing, with respect to the structural member 110. In some aspects, as shown, the washer 166 can be a flat or smooth washer.

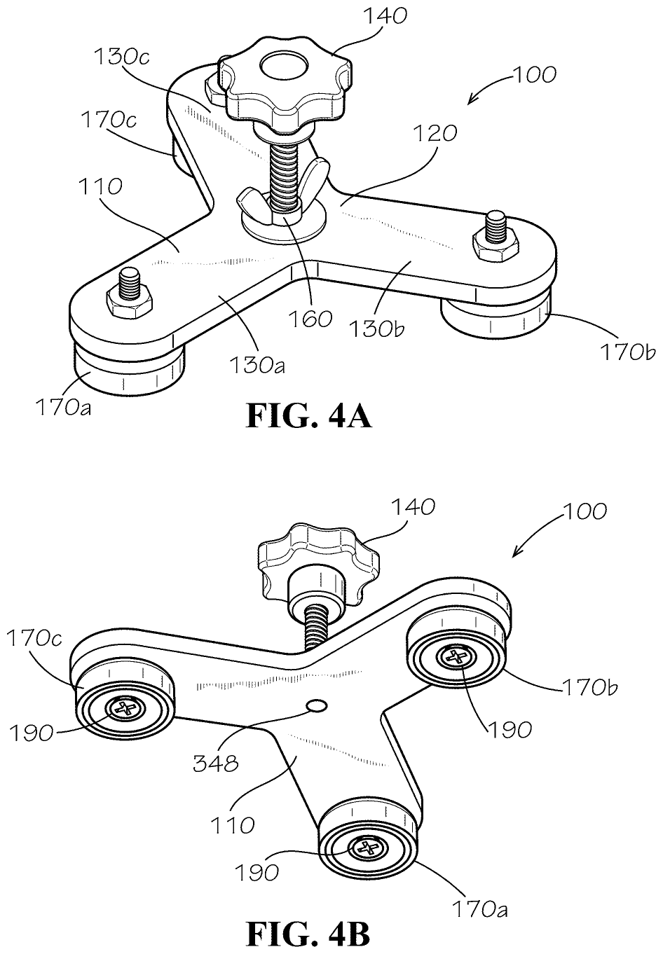

FIG. 4A is a top perspective view and FIG. 4B is a bottom perspective view of the tool 100 in accordance with another aspect of the current disclosure. In some aspects, as shown, the structural member 110 can comprise the hub 120 and three arms 130a,b,c extending from the hub 120. In some aspects, the structural member 110 can comprise a single arm 130. In some aspects, the structural member 110 can comprise more than three arms 130. In some aspects, the structural member 110 can comprise a plate without separate arms per se, and mounting fasteners such as the mounting fasteners 170a,b,c can be arranged on and secured to the plate at a desired distance from each other so as to define a space therebetween for the first end 145 (shown in FIG. 3B) of the holding fastener 140. In some aspects, as shown, the tool 100 can have planar and radial symmetry in the arrangement of the holding fastener 140, the mounting fasteners 170a,b, the arms 130a,b,c, and any one or more other components. In some aspects, the tool 100 need not have planar or radial symmetry in the arrangement of the holding fastener 140, the mounting fasteners 170a,b, or any other components. For example and without limitation, instead of the holding fastener 140 being positioned halfway between the mounting fasteners 170 in the X-axis direction, the holding fastener 140 can be positioned anywhere between the mounting fasteners 170 or can be offset from each of the mounting fasteners 170 in the same direction. For example, the first mounting fastener 170a, the second mounting fastener 170b, and then the holding fastener 140 can be arranged sequentially on the structural member 110. Each of the arms 130a,b,c can define a length measured from a center of the hub 120 of the structural member 110 and can define a width measured in a distance orthogonal to the length thereof. In some aspects, the structural member 110 can define an overall diameter.

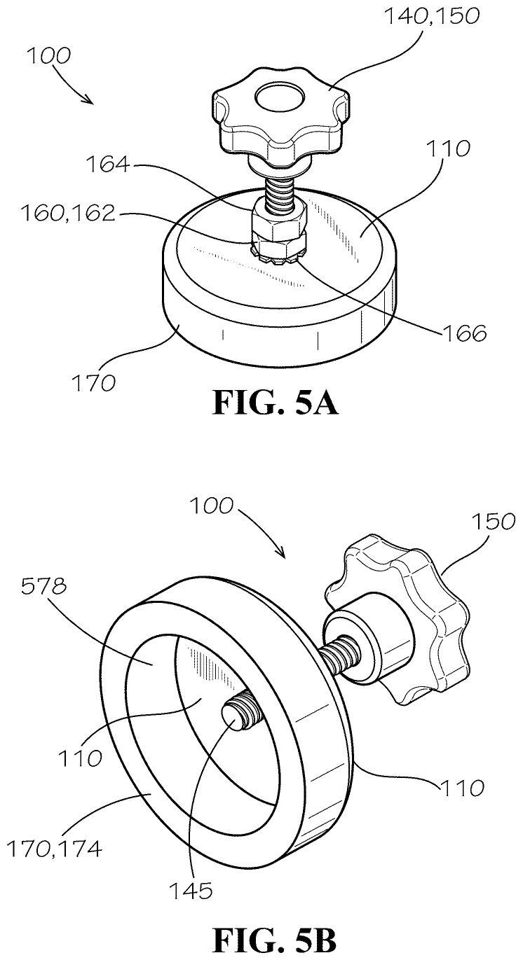

FIG. 5A is a top perspective view and FIG. 5B is a bottom perspective view, of the tool 100 in accordance with another aspect of the current disclosure. The structural member 110 can be a disc, and the mounting fastener 170 can comprise a single magnet through which the holding fastener 140 can extend. As shown, the magnet can define an annular or “donut” shape defining a central cavity 578 (shown in FIG. 5B) therein. The mounting fastener 170 can be joined or secured to the structural member 110 with an adhesive or other fastener. In some aspects, the main portion 150 and, in some aspects, the locking portion 160 can be secured directly to the mounting fastener 170 without the structural member 110 positioned therebetween. In some aspects, a second locking fastener 164 can be tightened against the locking fastener 162 to resist or prevent rotation of the holding fastener 140 with respect to the locking portion 160 or the mounting fastener 170.

Momentarily skipping FIGS. 6-9, FIG. 10 is a side exploded view of the tool 100 comprising suction cups as the mounting fasteners 170a,b in accordance with another aspect of the current disclosure. As shown, each of the openings 398 can be sized and otherwise configured to receive the corresponding mounting fastener 170a,b itself. More specifically, each of the openings 398 can extend from the respective ends 115,116 of the structural member 110 and can define a locking portion 1010 to secure a portion of the mounting fastener 170a,b and a pass-through portion 1020 for allowing the mounting fastener 170a,b to be more easily assembled. In some aspects, the structural member 110 need not define the pass-through portion 1020. Each of the mounting fasteners 170a,b can define grooves 1070 for engaging with or receiving the structural member 110 without necessarily the fasteners 190 (shown in FIG. 1A). When present, the openings 378 can extend only partially through the mounting fasteners 170a,b to facilitate suction by definition of a closed space between each of the mounting fasteners 170a,b and the mounting structure, e.g., the bucket 610 (shown in FIG. 7). Each of the suction cups forming the mounting fasteners 170a,b can be formed from any elastic material such as, for example and without limitation, natural or synthetic rubber, EPDM, or silicone.

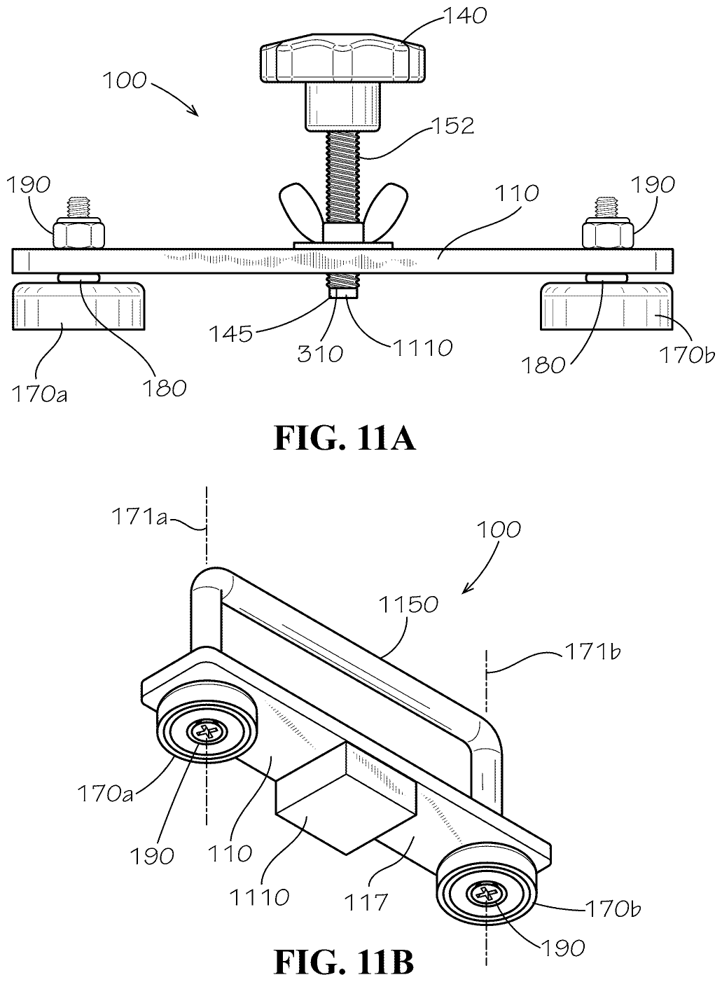

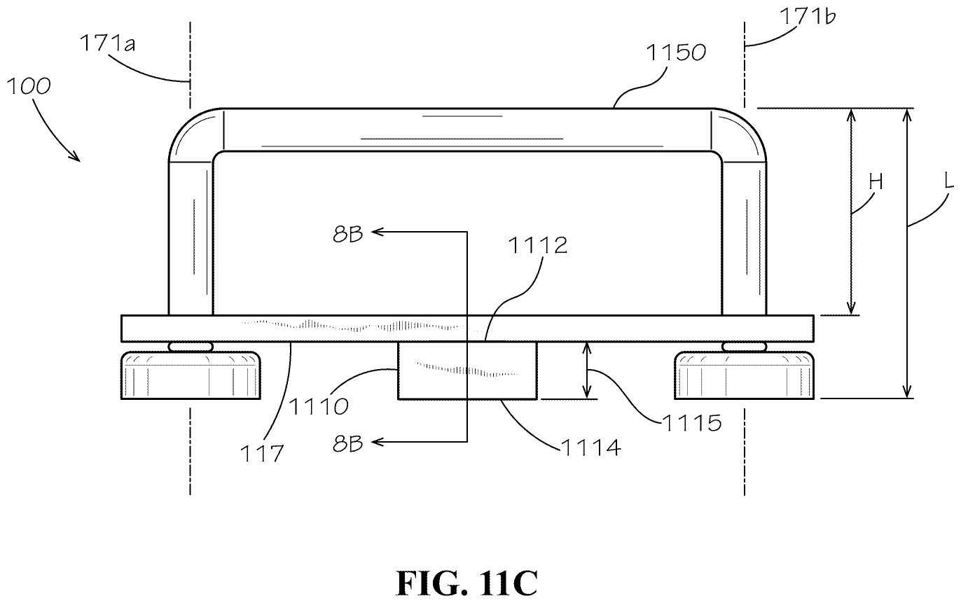

FIG. 11A is a side view of the tool 100 in accordance with another aspect of the current disclosure. As shown, one of an elastic and compressive material such as, for example, any one or more of the materials forming the spacer 180 can form a spacer 1110, which can be secured to the holding fastener 140. In some aspects, an inflated or inflatable air bladder or gas-filled bladder can define the spacer 1110. The spacer 1110, including the spacer 1110 shown in FIG. 11A or 11B, can compress and can apply pressure to a portion of the fastener assemblies 690 with the use of the holding fastener 140 or, as shown in FIG. 8B, without the holding fastener 140. The spacer 1110 can be positioned at the first end 145 of the holding fastener 140 and can define the first end 145. The spacer 1110 can be secured with an adhesive, which can be applied to a first surface 1112 (shown in FIG. 110) of the spacer 1110. In some aspects, as shown, the spacer 1110 or a maximum dimension thereof can be smaller than a diameter of the shaft 152 of the holding fastener 140. In some aspects, a diameter or maximum dimension of the spacer 1110 can be greater than a diameter of the shaft 152 of the holding fastener 140. In some aspects, the spacer 1110 can be attached to and can optionally cover the tip 310 of the holding fastener 140. In some aspects, the spacer 1110 can be secured to a surface of the tool 100 shown in FIGS. 5A and 5B and positioned inside the cavity 578 (shown in FIG. 5B) defined by the mounting fastener 170.

FIGS. 11B and 110 show the tool 100 in accordance with another aspect of the current disclosure. FIG. 11B is a bottom perspective view and FIG. 110 is a side view of the tool 100. The tool 100 need not comprise the holding fastener 140 at all. In some aspects, as shown, the tool 100 can comprise a handle 1150 and can also comprise the mounting fastener 190a,b—and integrally so, as also shown. More specifically, in some aspects, the fastener 190 can secure both the corresponding mounting fastener 170a,b and the handle 1150 to the structural member 110, including along respective axes 171a,b in some aspects. In some aspects, the handle 1150 need not be a separate component of the tool 100 and can be formed from the structural member 110. More specifically, the structural member 110 can be monolithically formed with the handle 1150, i.e., it can be formed as a singular component that constitutes a single material without joints or seams. As shown in FIG. 11C, the handle 1150 can define a height H, which can—together with a height of the mounting fasteners 170a,b and any intervening parts such as the structural member 110—define a lever arm or lever distance L. In some aspects, as shown, the spacer 1110 of the tool 100 can be secured to and extend from the first side 117 of the structural member 110. Again, the spacer 1110 can be secured with an adhesive applied to the first surface 1112, which can be distal from a second surface 1114 of the spacer 1110. In some aspects, being formed one of an elastic and a compressible material, the spacer 1110 can compress when installed in position. In some aspects, the spacer 1110 can be formed from a rigid material and a thickness 1115 thereof can be set to maintain a position of the first connecting portion 692 (shown in FIG. 6) of the fastener assembly 690 (shown in FIG. 6). In some aspects, the structural member 110 itself can be shaped, e.g., with bending, to approach and contact, with or without the spacer 1110 (i.e., the structural member 110 can indirectly or directly contact), the first connecting portion 692 of the fastener assembly 690.

Returning to FIGS. 6-9, FIG. 6 is a front perspective view of the vehicle 600 comprising the bucket 610, the blade 650, and the plurality of fastener assemblies 690 securing the blade 650 to the bucket 610 in accordance with one aspect of the current disclosure. Each of the fastener assemblies 690 can comprise the first connecting portion 692 and a second connecting portion 694. For example and without limitation, the first connecting portion 692 can be a bolt and the second connecting portion 694 can be a nut. More specifically, in some aspects, the first connecting portion 692 can be a carriage bolt, and the second connecting portion 694 can be a nut, which can optionally comprise or define a flange as shown in FIG. 8A. As shown, the first connecting portion 692 of any of the fastener assemblies 690 can extend upward from a bottom or outside of the bucket 610 through each of the blade 650 and a main portion 810 (shown in FIG. 8A) of the bucket 610. More broadly, the fastener assembly 690 can secure any of a first structure such as, for example and without limitation, the blade 650 to a second structure such as, for example and without limitation, the bucket 610. As shown, the first structure and the second structure can be a portion of a vehicle such as the vehicle 600. In other aspects, the first structure and the second structure can be part of any non-vehicle or even non-movable, i.e., stationary structure.

FIG. 7 is a side bottom perspective view of the tool 100 of FIG. 1A installed on the bucket 610 of the vehicle 600. As shown, the holding fastener 140 can be aligned with the fastener assembly 690 (shown in FIG. 8A) or, as shown, a recessed portion 758 in the bucket 610 or, more specifically, the blade 650 in which the fastener assembly 690 is received. As shown, each of the mounting fasteners 170a,b can be attracted to and secure to the bottom or outside surface of the bucket 610 or, more specifically, the blade 650, each of which can comprise or be formed from a ferromagnetic material such as steel.

FIG. 8A is a sectional view of the tool 100 of FIG. 1A installed on the bucket 610 of the vehicle 600 (shown in FIG. 6) and with the holding fastener 140 of the tool 100 in contact with the fastener assembly 690 of the bucket 610. As shown, a top or inside surface 851 of the blade 650, which can be a replacement “sacrificial element” of the bucket 610 to prolong use of a remaining portion of the bucket 610, can be mated or otherwise secured to a bottom or outside surface 812 of the main portion 810 of the bucket 610. As shown, the working surfaces 174 of the corresponding mounting fasteners 170a,b of the tool 100 can remain in flush or substantially flush (e.g., sufficiently close and/or parallel so as to remain in mating contact) with the blade 650, including when a surface 852, which can be a bottom or outer surface, of the blade 650 is not flat. More specifically, even though a portion of the blade 650 proximate to an edge 855—or any other portion of the blade 650 or, more generally, the bucket 610, may not lie in the same plane as neighboring portions of the same structure, the mounting fasteners can, as shown, be flexible enough to conform to the surface 852, which can be non-flat as shown. One or more of the mounting fasteners 170a,b, the spacers 180, and other elements of the tool 100 can facilitate such conformity with a mating surface of the bucket 610 such as the surface 852. As part of this, the axes 171a,b need not remain parallel during use of the tool 100. Instead, each individual mounting fastener 170a,b can be allowed to “float” or self-adjust such that it remains perpendicular to the mating surface to which the tool 100 is attached during use.

As shown, the first end 145 of the holding fastener 140 can be in contact with the fastener assembly 690 and, more specifically, the first connecting portion 692 to hold the first connecting portion 692 in place. The holding fastener 140 can hold the first connecting portion 692 in place even when the second connecting portion 694 is not present or when the second connecting portion 694 is loosened or even when a force pushing against a flange 896 of the second connecting portion 694 towards an outer surface 811 of the main portion 810 of the bucket 610 tends to push the first connecting portion 692 outward or downward or otherwise in a direction tending to separate the tool 100 from the mating structure. More specifically, the tool 100 can be configured to contact and maintain a position of the fastener assembly 690 in a direction of the axis 801 of the fastener assembly 690. The first end 145 of the holding fastener 140 can be brought in contact with the fastener assembly 690 by adjusting a distance 807 between the structural member 110 and a nearest portion, e.g., a head, of the first connecting portion 692 of the fastener assembly 690. More specifically, either or both of the axes 101,141 can be brought into alignment or substantial alignment with the axis 801. The ability to adjust the distance 807 can facilitate use of the tool 100 with a variety of different bolt sizes and degrees of wear, especially to a head of the first connecting portion or bolt 692. In some cases, for example, the head of the first connecting portion 692 can be completely worn and require greater extension of the first end 145 of the holding fastener 140. In some aspects, the fastener assembly 690 can comprise a low-profile (e.g., countersunk or otherwise short or flat-top) head, which the tool 100 and, more specifically, the distance 807 can also be adjusted to accommodate. The tool 100 and, more specifically, the distance 807 can also be adjusted to accommodate variance in a depth of the recessed portion 758.

FIG. 8B is a sectional view of the tool 100 similar to that of FIG. 8A but taken along line 8B-8B of FIG. 11C in accordance with one aspect of the current disclosure. More specifically, the spacer 1110 can be used with any tool 100 including the tool 100 of FIG. 1A. As shown, the spacer 1110 can contact, be compressed at least partially by, and form a depression complementary to a shape of a head of the first connecting portion 692 of the fastener assembly 690. The spacer 1110 can thus automatically accommodate a variety of sizes and/or conditions of wear of a head of the first connecting portion 692 of the fastener assembly 690. Again, each magnet 820 can be received within the respective fastener body 830 of the corresponding mounting fastener 170a,b.

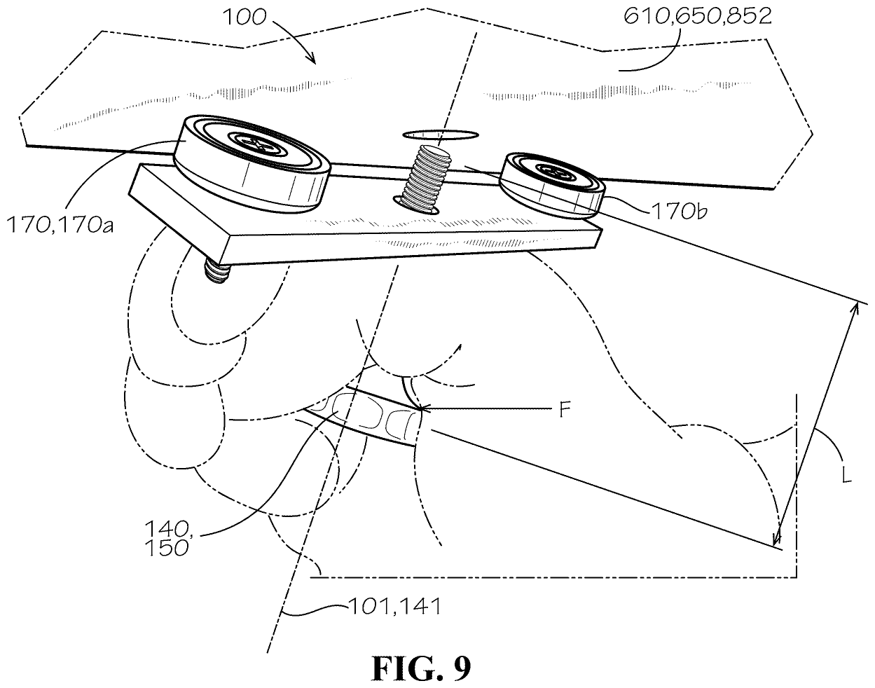

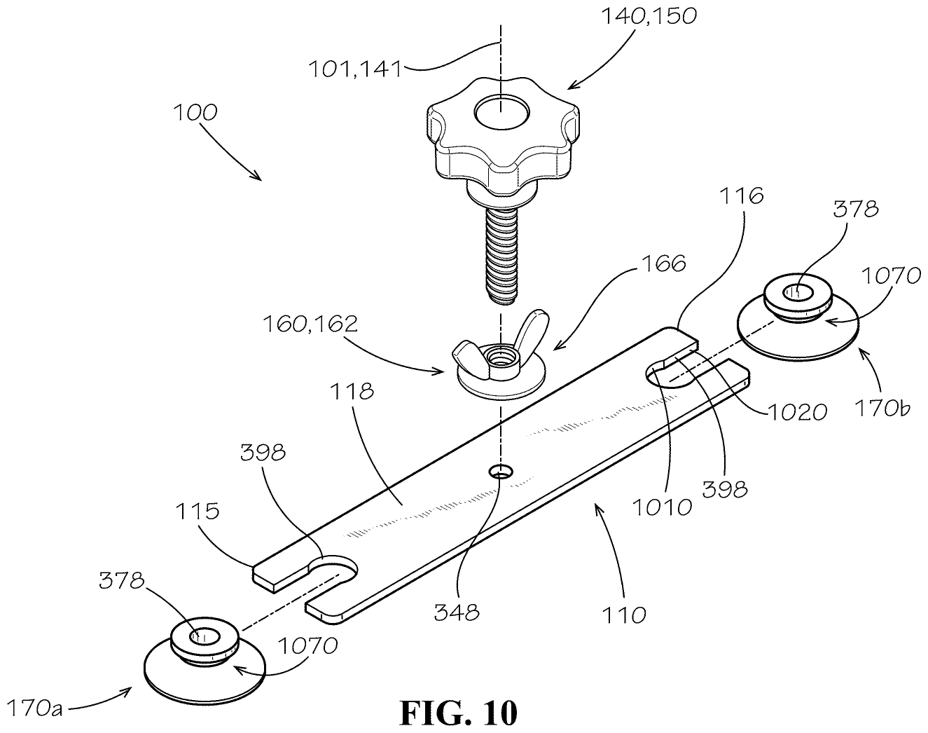

FIG. 9 is a side bottom perspective view of the tool 100 of FIG. 1A during removal of the tool 100 from the bucket 610 of the vehicle 600 (shown in FIG. 6) and, more specifically, the surface 852 of the blade 650. As shown, a user can apply a force F in a direction angled with respect to the axes 101,141 and thereby dislodge the tool 100 from the surface 852. By applying the force F more specifically against the main portion 150 of the holding fastener 140, a moment results, the moment (literally, a leveraged force) being roughly equal to the force F multiplied by a distance between the surface 852 and where the force F is applied such as the lever distance L. Even though a magnetic force produced by the mounting fasteners 170a,b (or, as an alternative, a vacuum force produced by a mounting fastener comprising suction cups such as, for example and without limitation, that shown in FIG. 10) can require much greater force F to be removed in a direction parallel with the axis 101 of the tool 100, such force F can be reduced by angling the force with respect to the axis 101. For example, with the magnetic attachment force of a single mounting fastener being over 50 pounds, the removal force F may need to be 100 to 150 pounds to remove the tool in the direction parallel with the axis 101 of the tool 100.

In some aspects, the spacer 180 can be placed on the working surface 174 of the mounting fastener 170, e.g., with an adhesive, to facilitate conformance of the working surface 174 with the mating surface of the bucket 610. More specifically, in some aspects, a circular spacer 180 could be secured to the working surface 174 shown in FIG. 3B, or an annular or ring-shaped spacer 180 could be secured to the working surface 174 shown in FIG. 5B. In such aspects, it can be beneficial to use a compressible material to form the spacer 180. Because a gap can form between the working surface 174 of the mounting fastener 170 and the mating surface of the bucket 610 but the magnetic force of the mounting fastener 170 be sufficient to maintain its own position and thereby also the position of the tool 100, an entirety of the working surface 174 need not be in contact with the mating surface of the bucket 610.

A method of using the tool 100 can comprise brushing or otherwise cleaning a surface of the areas of a first structure and a second structure joined by the one or more fastener assemblies 690. The method can comprise aligning the axis 141 of the holding fastener 140 of the tool 100 with the first connecting portion 692 of the fastener assembly 690, in which case the fastener assembly 690 can secure a first structure to a second structure. The method can comprise securing the mounting fastener 170—or the mounting fasteners 170a,b, as also in the case of any other structures or method steps disclosed herein—of the tool 100 to the first structure, in which case the mounting fastener 170 can be configured to hold itself in place against a mating surface of the first structure (e.g., the surface 852 of the blade 650). In some aspects, the method can comprise adjusting a position of the holding fastener 140 with respect to the structural member 110 joining the holding fastener 140 to the mounting fastener 170 to prevent dislocation of the first connecting portion 692 from the first structure. The method of adjusting the position of the holding fastener 140 can comprise adjusting and, more specifically, rotating the holding fastener until the first end 145 thereof contacts the first connecting portion 692 of the fastener assembly 690. In some aspects, no holding fastener 140 and therefore no adjusting thereof is necessary. More specifically, the method can comprise contacting the first connecting portion 692 of the fastener assembly 690 with the tool 100. In some aspects, contacting the first connecting portion 692 of the fastener assembly 690 with the tool 100 can comprise contacting the fastener assembly 690 with the spacer 1110. In some aspects, contacting the first connecting portion 692 of the fastener assembly 690 with the tool 100 can comprise compressing the spacer 1110. In some aspects, contacting the first connecting portion 692 of the fastener assembly 690 with the tool 100 can comprise directly contacting the first connecting portion 692 with the structural member 110.

The method can comprise removing the second connecting portion 694 of the fastener assembly 690 from the first connecting portion 692 to disassemble the fastener assembly 690, which again can comprise both of the first connecting portion 692 and the second connecting portion 694. The method can comprise removing the tool 100 by applying the force F to a portion of the tool 100. More specifically, the method of removing the tool 100 can comprise applying the force F to a portion of the tool 100 in a direction that is angled with respect to an axis 101 of the tool 100, which can include rocking the tool with a side force. In some aspects, removing the tool 100 can comprise sliding the tool 100 across the mating surface (e.g., the surface 852) until one of more of the mounting fasteners 170a,b of the tool 100 disengage from the mating surface. In some aspects, removing the tool 100 can comprise tightening the holding fastener of the tool 100 to push against a portion of the mating surface and/or the fastener assembly and thereby lift the tool 100 from the mating surface. The method can comprise installing a new first structure such as a new blade 650 and inserting each of a plurality of new first connecting portions or bolts 692 into corresponding holes in the bucket 610. The method can comprise installing the tool 100 at each position of one of the first connecting portions 692 and tightening, hands-free, the second connecting portion 694 from the top or opposite side. The method can therefore facilitate safe and consistent removal of any number of old fastener assemblies 690, installation of any number of new fastener assemblies 690, or both removal and installation. Because the tool 100 and not a user's hand holds the first connecting portion 692 in place, the user can avoid the impact and potential consequences (e.g., injury) of fatigue, insufficient training, or poor judgment on the removal and replacement process. Including in each of the above uses, the tool 100 can effectively be used to facilitate replacement of bolts such as the fastener assemblies 690 by retaining such bolts in position so that they can be extracted once disassembly is complete.

In other aspects, the tool need not hold a fastener in place but can hold a small piece of magnetic or other material during a fabrication process such as one involving drilling of a hole through a piece of sheetmetal material. A method of using the tool 100 to facilitate fabrication of a sheetmetal material can comprise aligning an axis 141 of the holding fastener 140 and specifically an axis of the tip 310 (shown in FIG. 3A), which can be secured to and/or can extend from the shaft 152 of the holding fastener 140, with a desired hole location on a backside or bottom side of the sheetmetal material. The method can comprise securing the mounting fastener 170 of the tool 100 to the sheetmetal material. The method can comprise adjusting a position of the holding fastener 140 with respect to a structural member 110 joining the holding fastener 140 to the mounting fastener 170 to prevent deformation of the sheetmetal material during the drilling process. The method can comprise drilling or otherwise forming a hole in the sheetmetal material from the front side or topside of the sheetmetal material with the tool 100 remaining on the backside or bottom side of the material. The method of drilling or otherwise forming the hole in the sheetmetal material can comprise receiving a drilling bit or other bit within a clearance opening 318 (shown in FIG. 3A) of the tip 310 without damage to the tip 310. The method can comprise removing the tool 100 through any one or more of the methods described above. In some aspects, the tip 310 can be magnetic and can through magnetic attraction hold a portion of the sheetmetal material cut out such as in a drilling operation or plasma cutting operation to avoid loss, injury, or damage to equipment by such portion.

The components of the tool 100 and any portion thereof can be formed from any one of a variety of materials selected based on their strength characteristics, weight, and cost. In some aspects, it will be beneficial to select a material with sufficient strength to avoid deformation, corrosion, or fatigue in use. In some aspects, for example, the structural member 110 and any portion of one or more of the holding fastener 140, the mounting fastener(s) 170, the fastener(s) 190, and any other portion of the tool 100 can be formed from a material such as steel or aluminum, which can be cast, molded, and/or machined to produce any of the features disclosed herein. In some aspects, the tool 100 or portions thereof can be formed from a zinc-plated, galvanized, or stainless steel or other corrosion-resistant material or from a material such as carbon or tool steel that is less corrosion-resistant. In other aspects, another material can be used for any of the parts such as, for example and without limitation, a metal other than steel, a composite material, or a polymer resin—including of the fiber-reinforced kind. In some aspects, as shown, the tool 100 or portions thereof can be formed from sheet metal through traditional sheet metal forming processes. In other aspects, the structure can be formed from a powder in a three-dimensional printing process, from pellets in a molding process, or from another raw material and/or forming process. In some aspects, components such as the spacer 180 (shown in FIG. 1B) can be configured and selected to deform, in which case a material with appropriate characteristics such as, for example and without limitation, rubber or foam can be used. In other aspects, another material can be used for the parts configured to deform such as, for example and without limitation, a metal such as spring steel.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A tool comprising:
a structural member defining a hub and at least one arm extending from the hub; and
a mounting fastener secured to the arm of the structural member at a position distal from the hub and configured to automatically adjust to and hold itself in place against a non-flat mating surface of a structure, the tool configured to contact and maintain a position of a fastener assembly in a direction of an axis of the fastener assembly.

2. The tool of claim 1, further comprising one of a spacer and a holding fastener secured to the structural member and extending from the structural member, the one of the spacer and the holding fastener configured to contact and maintain the position of the fastener assembly, the spacer comprising at least one of an elastic and a compressible material.

3. The tool of claim 2, wherein the one of the spacer and the holding fastener is the holding fastener, a tip of the holding fastener defining a cavity.

4. The tool of claim 2, wherein the one of the spacer and the holding fastener is the holding fastener, the holding fastener being adjustably secured to the structural member and extending through the hub of the structural member, a position of the tip of the holding fastener being adjustable with respect to the structural member.

5. The tool of claim 4, wherein the holding fastener comprises a main portion and a locking portion, the holding fastener configured to adjust the position of the tip of the holding fastener by rotating the main portion with a hand of a user of the tool.

6. The tool of claim 1, wherein the mounting fastener comprises one of a magnet and a suction cup.

7. The tool of claim 6, wherein the mounting fastener comprises the magnet, the magnet defining a magnetic force in a range of 15 to 120 pounds.

8. The tool of claim 1, further comprising a handle extending from the structural member, the mounting fastener extending from a first side of the structural member and the handle extending from a second side of the structural member, the second side facing opposite from the first side.

9. The tool of claim 1, further comprising a spacer positioned between the mounting fastener and the structural member, the spacer comprising at least one of an elastic and a compressible material and configured to allow movement of the mounting fastener with respect to the structural member.

10. The tool of claim 1, wherein an axis of the mounting fastener is angled with respect to a working surface of the mounting fastener.

11. A tool comprising:
a mounting fastener configured to hold itself in place against a mating surface of a structure, the mounting fastener comprising a magnet; and
one of a spacer and a holding fastener, the one of the spacer and the holding fastener secured to a surface of the tool, the one of the spacer and the holding fastener positioned inside a cavity defined by the mounting fastener, a position of a surface of the spacer and a tip of the holding fastener being adjustable with respect to a working end of the mounting fastener in a direction of an axis of a fastener assembly, the one of the spacer and the holding fastener configured to contact and maintain a position of the fastener assembly extending through the structure in the direction of the axis of the fastener assembly.

12. The tool of claim 11, further comprising a structural member, the mounting fastener secured to the structural member, the holding fastener also adjustably secured to and extending through the structural member.

13. The tool of claim 11, wherein the one of the spacer and the holding fastener is the holding fastener, the holding fastener comprises a main portion and a locking portion, the holding fastener configured to adjust the position of the tip of the holding fastener by rotating the main portion with a hand of a user of the tool, the locking portion configured to lock the position of the tip of the holding fastener with respect to the a working surface of the mounting fastener.

14. The tool of claim 11, wherein the one of the spacer and the holding fastener is the holding fastener, wherein the holding fastener comprises a knob.

15. The tool of claim 11, wherein the mounting fastener defines a cavity through which the holding fastener extends at least partially.

16. The tool of claim 11, wherein the mounting fastener defines an annular shape.

17. A method of using a tool, the method comprising:
aligning one of a spacer and a holding fastener of the tool with a first connecting portion of a fastener assembly, the fastener assembly configured to secure a first structure to a second structure, the first structure being a wearable blade; and
securing a mounting fastener of the tool to the first structure, the mounting fastener configured to automatically adjust to and hold itself in place against a non-flat mating surface of the first structure.

18. The method of claim 17, wherein the one of the spacer and the holding fastener is the holding fastener, the method further comprising adjusting the holding fastener to contact and maintain a position of the first connecting portion with respect to the first structure and thereby prevent premature dislocation of the first connecting portion from the first structure.

19. The method of claim 17, further comprising:
one of installing and removing a second connecting portion from the first connecting portion to, respectively, assemble or disassemble the fastener assembly without a user of the tool contacting or supporting the first connecting portion except with the tool,
wherein the fastener assembly comprises the first connecting portion and the second connecting portion.

20. The method of claim 17, further comprising removing the tool by applying a force to a portion of the tool offset a lever distance from a working surface of the mounting fastener of the tool and in a direction angled with respect to an axis of the tool.
